(19) United States
(12) Patent Application Publication
(10) Pub. No.: US 2017/0168770 A1
(43) Pub. Date: Jun. 15, 2017

(54) ELECTRONIC DEVICE AND METHOD FOR ONBOARD DISPLAY CONTROL

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Yonggui ZHAO, Tianjin (CN)

(21) Appl. No.: 15/250,548

(22) Filed: Aug. 29, 2016

Related U.S. Application Data
(63) Continuation of application No. PCT/CN2016/088546, filed on Jul. 5, 2016.

(30) Foreign Application Priority Data
Dec. 14, 2015 (CN) 201510933441.1

(51) Int. Cl. G06F 3/14; H04W 84/18; G06F 3/0484; H04L 29/08

(52) U.S. Cl. CPC G06F 3/1454; H04L 67/12; H04W 84/18; G06F 3/04847

(57) ABSTRACT

A vehicle-mounted display control method and an electronic device thereof are disclosed, applied to a vehicle-mounted system, the vehicle-mounted system being connected to a portable terminal. The method includes: receiving interface information sent by the portable terminal, and displaying a virtual interface according to the interface information; receiving an input instruction via the virtual interface, and sending an operation instruction generated according to the input instruction to the portable terminal; and receiving and outputting operation data generated by the portable terminal according to the operation instruction. According to the present disclosure, resources are shared between the vehicle-mounted system and the portable terminal, the display and play effects of the portable terminal are improved, and the disclosure of the vehicle-mounted system is extended.

### CROSS REFERENCE TO RELATED APPLICATIONS

This application is a continuation of PCT Application No. PCT/CN2016/088546 filed on Jul. 5, 2016, and is based upon and claims priority to Chinese Patent Application No. 201510933441.1, filed before Chinese Patent Office on Dec. 14, 2015 and entitled “ELECTRONIC DEVICE AND METHOD FOR ONBOARD DISPLAY CONTROL”, the entire contents of which are incorporated herein by reference.

### TECHNICAL FIELD

The present disclosure relates to the technical field of vehicle-mounted display control, and more particularly, to a vehicle-mounted display control method and an electronic device thereof.

### BACKGROUND

With the development of such portable terminals as smart phones, the convenience of display and operation greatly enriches people's life. However, the display screen of the portable terminal is generally small, and the play effect is very limited, causing restrictions to use thereof.

The vehicle-mounted system has better display and play effects. However, due to restrictions on the convenience and network acquisition capabilities, further services may not be provided for the driver and passengers.

During implementation of the present disclosure, the inventors have identified that the related art at least has the following technical problem: generally, the vehicle-mounted system and the portable terminal fail to implement resource sharing, and thus the functions of the vehicle-mounted system may not be improved based on the convenience and network acquisition capabilities of the portable terminal.

Therefore, it is a technical problem to be urgently solved in the related art as how to share resources between the vehicle-mounted system and the portable terminal.

### SUMMARY

In view of the above, the present disclosure provides a vehicle-mounted display control method and an electronic device thereof, which implement resource sharing between a vehicle-mounted system and a portable terminal, thereby improving the display and play effects of the portable terminal, and extending the disclosure of the vehicle-mounted system.

Embodiments of the present disclosure provide a vehicle-mounted display control method, applied to a vehicle-mounted system, the vehicle-mounted system being connected to a portable terminal. The method includes:

receiving interface information sent by the portable terminal, and displaying a virtual interface according to the interface information;

receiving an input instruction via the virtual interface, and sending an operation instruction generated according to the input instruction to the portable terminal; and

receiving and output operation data generated by the portable terminal according to the operation instruction.

Embodiments of the present disclosure further provide a non-volatile computer storage medium which stores computer executable instructions, wherein the computer executable instructions are executed to:

receive interface information sent by the portable terminal, and display a virtual interface according to the interface information;

receive an input instruction via the virtual interface, and send an operation instruction generated according to the input instruction to the portable terminal; and

receive and output operation data generated by the portable terminal according to the operation instruction.

Embodiments of the present disclosure further provide an electronic device, including:

at least one processor; and

a memory communicably connected to the at least one processor; wherein

the memory stores instructions executable by the at least one processor, wherein, the instructions, when being executed by the at least one processor, cause the at least one processor to:

receive interface information sent by the portable terminal, and display a virtual interface according to the interface information;

receive an input instruction via the virtual interface, and send an operation instruction generated according to the input instruction to the portable terminal; and

receive and output operation data generated by the portable terminal according to the operation instruction.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram illustrating a vehicle-mounted system applied in the present disclosure;

FIG. 2 is a flowchart illustrating a vehicle-mounted display control method according to some embodiments of the present disclosure;

FIG. 3 is a flowchart illustrating step S1 in a vehicle-mounted display control method according to some embodiments of the present disclosure;

FIG. 4 is a schematic structural diagram illustrating an interface displayed in the vehicle-mounted system applied in the present disclosure.

FIG. 5 is a schematic structural diagram illustrating a portable terminal applied in the present disclosure;

FIG. 6 is a flowchart illustrating a vehicle-mounted display control method according to some embodiments of the present disclosure;

FIG. 7 is a flowchart illustrating an electronic device for use in vehicle-mounted display control according to some embodiments of the present disclosure;

FIG. 8 is a flowchart illustrating virtual display modules in the electronic device for use in vehicle-mounted display control according to some embodiments of the present disclosure;

FIG. 9 is a flowchart illustrating an electronic device for use in vehicle-mounted display control according to some embodiments of the present disclosure;

FIG. 10 is a schematic diagram illustrating an disclosure scenario of a vehicle-mounted display control method according to some embodiments of the present disclosure;

FIG. 11 is a flowchart illustrating an disclosure scenario of a vehicle-mounted display control method according to some embodiments of the present disclosure; and

FIG. 12 is a schematic structural diagram illustrating hardware of an electronic device for performing the vehicle-mounted display control according to some embodiments of the present disclosure.

### DETAILED DESCRIPTION

According to embodiments of the present disclosure, a vehicle-mounted system is connected to a portable terminal, wherein the vehicle-mounted system receives interface information sent by the portable terminal, and displays a virtual interface according to the interface information. The virtual interface receives an input instruction, and sends an operation instruction generated according to the input instruction to the portable terminal. The portable terminal generates corresponding operation data according to the operation instruction, and the vehicle-mounted system receives and outputs the operation data generated by the portable terminal according to the operation instruction. According to the present disclosure, resources are shared between the vehicle-mounted system and the portable terminal, the display and play effects of the portable terminal are improved, and the disclosure of the vehicle-mounted system is extended.

Definitely, the implementation of any technical solution of the present disclosure does not need to achieve all the above advantages.

To make a person skilled in the art better understand the technical solutions of the present disclosure, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by a person of ordinary skill in the art shall fall within the protection scope of the present disclosure.

Specific implementations of the present disclosure are further described hereinafter with reference to drawings of the present disclosure.

A specific embodiment of the present disclosure provides a vehicle-mounted display control method, applied to a vehicle-mounted system, the vehicle-mounted system being connected to a portable terminal. Specifically, the vehicle-mounted system may be connected to the portable terminal via a local area network.

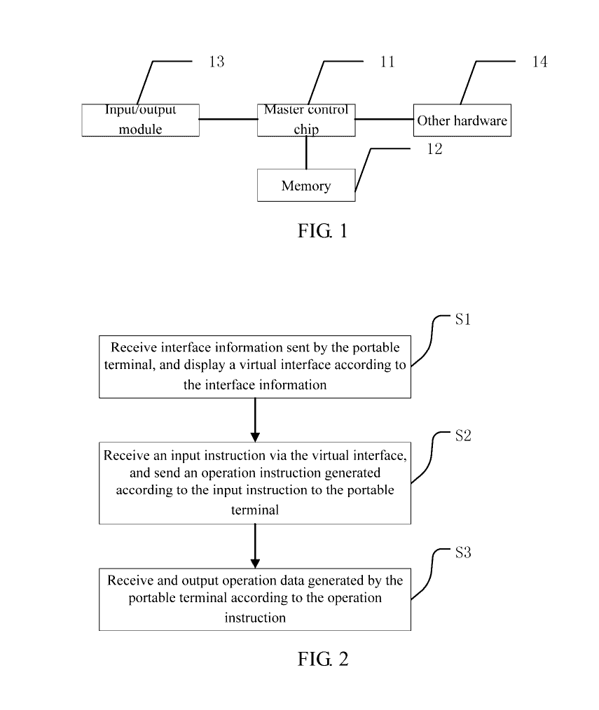

Referring to FIG. 1, the vehicle-mounted system may be a vehicle computer or the like, and includes in terms of hardware: a control chip 11, a memory 12, an input/output module 13, and hardware 14. The control chip 11 controls various functional modules, the memory 12 stores various disclosures and data, and the input/output module 13 is configured to implement input and output.

Referring to FIG. 2, the vehicle-mounted display control method includes the following steps:

S1: Interface information sent by the portable terminal is received, and a virtual interface is displayed according to the interface information.

In a specific embodiment of the present disclosure, referring to FIG. 3, step S1 includes:

S11: Interface image information and interface control information provided by the portable terminal are received.

The portable terminal sends the interface image information and the interface control information displayed thereon to the vehicle-mounted system, to ensure that the vehicle-mounted system is capable of displaying an interface that is the same as the portable terminal, and acquiring a control operation that is the same as the display interface of the portable terminal.

Specifically, the interface image information includes at least one of: a display size, a color depth feature, a refresh rate and a resolution.

The interface control information includes operation information corresponding to the control.

S12: A virtual interface that is the same as the interface of the portable terminal is displayed according to the interface image information.

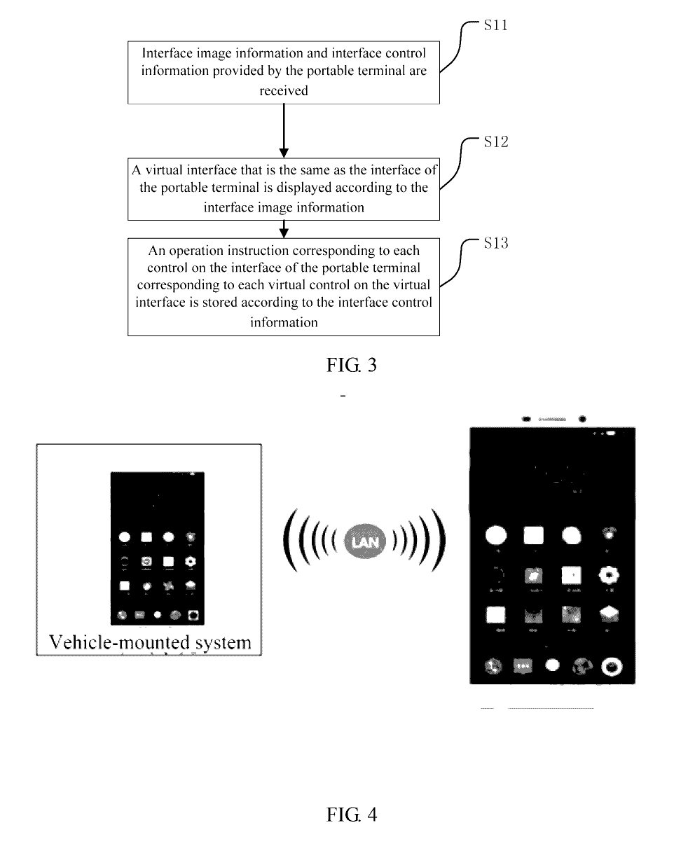

Referring to FIG. 4, the vehicle-mounted system displays a virtual interface that is the same as the interface of the portable terminal by receiving the interface image information sent by the portable terminal.

Specifically, the interface displayed by the portable terminal includes various interface elements presented to a user, which may employ a manner similar to screen copy and send a copied image of the screen of the portable terminal to the vehicle-mounted system, and make adaptive adjustments according to the screen of the vehicle-mounted system, such that the vehicle-mounted system displays the virtual interface that is the same as the interface of the portable terminal.

S13: An operation instruction corresponding to each control on the interface of the portable terminal corresponding to each virtual control on the virtual interface is stored according to the interface control information.

Specifically, the interface displayed by the portable terminal includes various controls for controlling the portable terminal, including various touch keys, such that the user may send operation instructions to the portable terminal by using the controls. In this way, events corresponding to the operation instructions are generated, and operation data corresponding to the operation instructions is generated.

Referring to Table 1, various controls on the interface of the portable terminal and operation instructions corresponding to the controls are exemplarily illustrated.

TABLE 1

| Control | Operation instruction |
|---|---|
| Camera | Take a photograph |
| Telephone | Make a call |
| . . . | . . . |
| Video APP | Play a video |

The vehicle-mounted system enables, according to the interface control information sent by the portable terminal, the virtual controls on the virtual interface to correspond to the controls on the interface of the portable terminal, to ensure that the various virtual controls on the virtual interface correspond to the operation instructions of the various controls on the interface of the portable terminal.

Referring to Table 2, virtual controls on the virtual interface of the vehicle-mounted system and operation instructions corresponding to various controls on the interface of the portable terminal are exemplarily illustrated.

TABLE 2

| Virtual control | Control | Operation instruction |
|---|---|---|
| Camera | Camera | Take a photograph |
| Telephone | Telephone | Make a call |
| . . . | . . . | . . . |
| Video APP | Video APP | Play a video |

S2: An input instruction is received via the virtual interface, and an operation instruction generated according to the input instruction is sent to the portable terminal.

Specifically, the vehicle-mounted system displays a virtual interface that is the same as that of the portable terminal, and receives input instructions via virtual controls on the virtual interface. By means of querying in Table 2, operation instructions corresponding to the input instructions of the virtual controls are acquired, and then the operation instructions are sent to the portable terminal. For example, the user may generate an operation instruction for making a call by touch a call key, and send the operation instruction for making a call to the portable terminal.

The portable terminal performs corresponding operations according to the operation instruction, generates corresponding operation data, and sends the generated operation data to the vehicle-mounted system. For example, the portable terminal makes a call according to the operation instruction for making a call, generates call data, and sends the call data to the vehicle-mounted system.

S3: Operation data generated by the portable terminal according to the operation instruction is received and output.

The vehicle-mounted system receives the operation data generated according to the operation instructions that is sent by the portable terminal, and outputs the operation data via a display and a player of the vehicle-mounted system.

The size of the display in the input/output module 13 of the vehicle-mounted system is greater than that of the portable terminal, and the player achieves a better play effect. Therefore, the operation data output by the vehicle-mounted system may achieve a better effect and user experience.

According to the present disclosure, resources are shared between the vehicle-mounted system and the portable terminal, the display and play effects of the portable terminal are improved, and the disclosure of the vehicle-mounted system is extended.

Another specific embodiment of the present disclosure provides a vehicle-mounted display control method, applied to a portable terminal, the portable terminal being connected to a vehicle-mounted system. Specifically, the vehicle-mounted system may be connected to the portable terminal via a local area network.

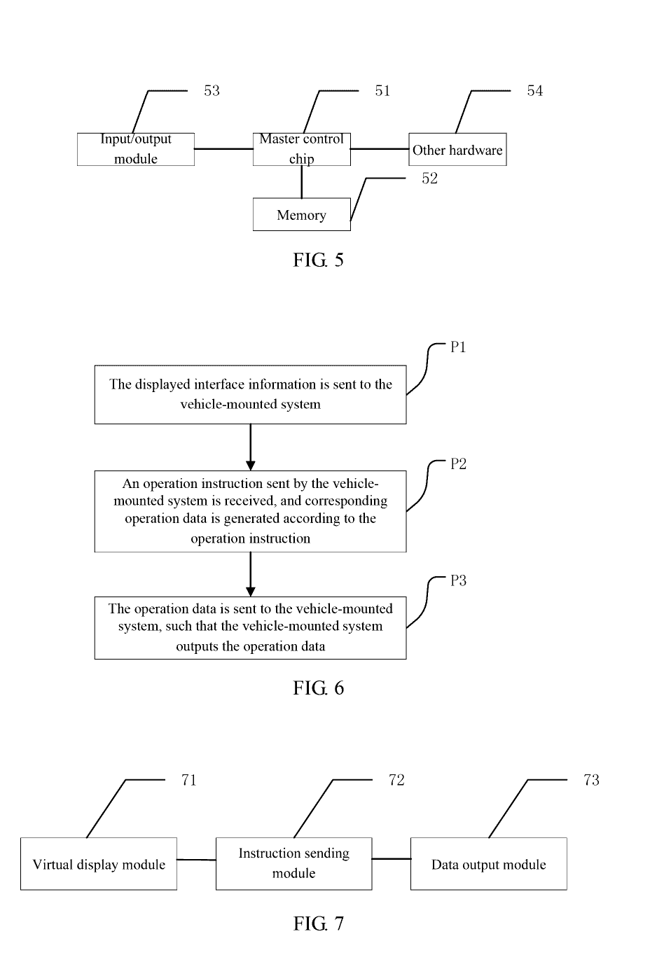

Referring to FIG. 5, the portable terminal may be generally a Pad, a smart phone or the like electronic device, and include in terms of hardware: a control chip 51, a memory 52, an input/output module 53, and hardware 54. The control chip 51 controls various functional modules, the memory 52 stores various disclosures and data, and the input/output module 53 is configured to implement input and output.

Referring to FIG. 6, the vehicle-mounted display control method includes the following steps:

P1: The displayed interface information is sent to the vehicle-mounted system.

The portable terminal sends the interface image information and the interface control information displayed thereon to the vehicle-mounted system, to ensure that the vehicle-mounted system is capable of displaying an interface that is the same as the portable terminal, and acquiring a control operation that is the same as the display interface of the portable terminal.

The portable terminal sends the displayed interface information to the vehicle-mounted system. Specifically, the interface information includes: interface image information and interface control information.

The interface image information includes at least one of: a display size, a color depth feature, a refresh rate and a resolution.

The interface image information includes at least one of: a display size, a color depth feature, a refresh rate and a resolution.

Specifically, the interface displayed by the portable terminal includes various interface elements presented to a user, which may employ a manner similar to screen copy and send a copied image of the screen of the portable terminal to the vehicle-mounted system, and make adaptive adjustments according to the screen of the vehicle-mounted system, such that the vehicle-mounted system displays the virtual interface that is the same as the interface of the portable terminal.

The interface displayed by the portable terminal includes various controls for controlling the portable terminal, including various touch keys, such that the user may send operation instructions to the portable terminal by using the controls. In this way, events corresponding to the operation instructions are generated, and operation data corresponding to the operation instructions is generated.

Referring to Table 1, various controls on the interface of the portable terminal and operation instructions corresponding to the controls are exemplarily illustrated.

TABLE 1

| Control | Operation instruction |
|---|---|
| Camera | Take a photograph |
| Telephone | Make a call |
| . . . | . . . |
| Video APP | Play a video |

Referring to FIG. 4, the vehicle-mounted system displays a virtual interface that is the same as the interface of the portable terminal by receiving the interface image information sent by the portable terminal.

The vehicle-mounted system enables, according to the interface control information sent by the portable terminal, the virtual controls on the virtual interface to correspond to the controls on the interface of the portable terminal, to ensure that the various virtual controls on the virtual interface correspond to the operation instructions of the various controls on the interface of the portable terminal.

Referring to Table 2, virtual controls on the virtual interface of the vehicle-mounted system and operation instructions corresponding to various controls on the interface of the portable terminal are exemplarily illustrated.

TABLE 2

| Virtual control | Control | Operation instruction |
|---|---|---|
| Camera | Camera | Take a photograph |
| Telephone | Telephone | Make a call |
| . . . | . . . | . . . |
| Video APP | Video APP | Play a video |

P2: An operation instruction sent by the vehicle-mounted system is received, and corresponding operation data is generated according to the operation instruction.

Specifically, the vehicle-mounted system displays a virtual interface that is the same as that of the portable terminal, and receives input instructions via virtual controls on the virtual interface. By means of querying in Table 2, operation instructions corresponding to the input instructions of the virtual controls are acquired, and then the operation instructions are sent to the portable terminal. For example, the user may generate an operation instruction for making a call by touch a call key, and send the operation instruction for making a call to the portable terminal.

The portable terminal receives operation instructions sent by the vehicle-mounted system, and generate corresponding operation data according to the operation instructions. For example, the portable terminal makes a call according to the operation instruction for making a call, and generates call data.

P3: The operation data is sent to the vehicle-mounted system, such that the vehicle-mounted system outputs the operation data.

The portable terminal sends the operation data generated according to the operation instructions to the vehicle-mounted system, and outputs the operation data via a display and a player of the vehicle-mounted system.

The size of the display in the input/output module 13 of the vehicle-mounted system is greater than that of the portable terminal, and the player achieves a better play effect. Therefore, the operation data output by the vehicle-mounted system may achieve a better effect and user experience.

According to the present disclosure, resources are shared between the vehicle-mounted system and the portable terminal, the display and play effects of the portable terminal are improved, and the disclosure of the vehicle-mounted system is extended.

Corresponding to the above method, a specific embodiment of the present disclosure provides an electronic device for use in vehicle-mounted display control, applied to a vehicle-mounted system, the vehicle-mounted system being connected to a portable terminal. Specifically, the vehicle-mounted system may be connected to the portable terminal via a local area network.

Referring to FIG. 1, the vehicle-mounted system may be a vehicle computer or the like, and includes in terms of hardware: a control chip 11, a memory 12, an input/output module 13, and hardware 14. The control chip 11 controls various functional modules, the memory 12 stores various disclosures and data, and the input/output module 13 is configured to implement input and output.

Referring to FIG. 7, the electronic device for use in vehicle-mounted display control includes:

a virtual display module 71, configured to receive interface information sent by the portable terminal, and display a virtual interface according to the interface information;

an instruction sending module 72, configured to receive an input instruction via the virtual interface, and send an operation instruction generated according to the input instruction the portable terminal; and

a data output module 73, configured to receive and output operation data generated by the portable terminal according to the operation instruction.

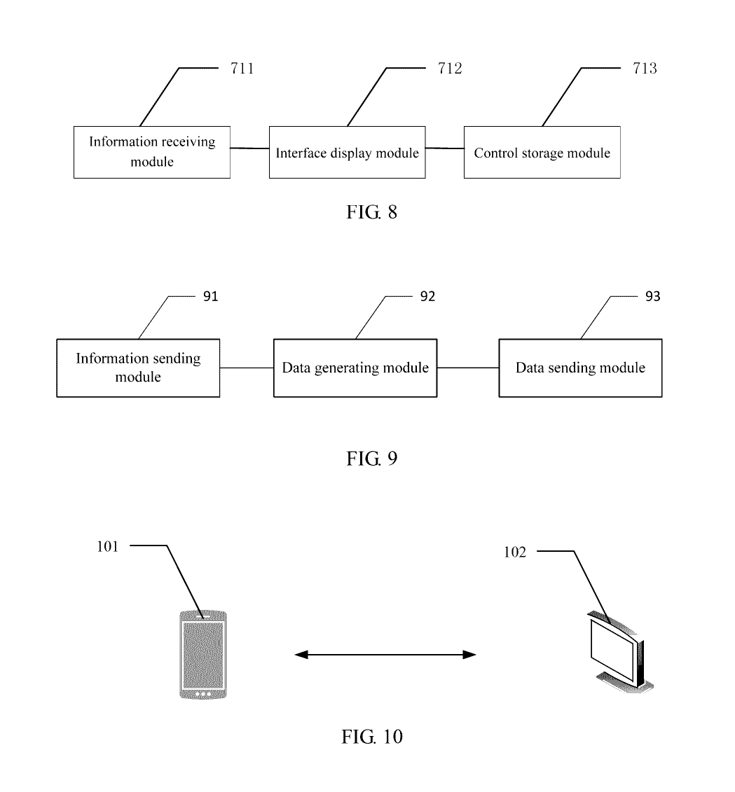

In a specific embodiment of the present disclosure, referring to FIG. 8, the virtual display module 71 includes:

an information receiving module 711, configured to receive interface image information and interface control information provided by the portable terminal;

an interface display module 712, configured to display, according to the interface image information, a virtual interface that is the same as the interface of the portable terminal is displayed; and

a control storage module 713, configured to store, according to the interface control information, an operation instruction corresponding to each control on the interface of the portable terminal corresponding to each virtual control on the virtual interface.

The portable terminal sends the interface image information and the interface control information displayed thereon to the vehicle-mounted system, to ensure that the vehicle-mounted system is capable of displaying an interface that is the same as the portable terminal, and acquiring a control operation that is the same as the display interface of the portable terminal.

Specifically, the interface image information includes at least one of: a display size, a color depth feature, a refresh rate and a resolution.

The interface control information includes operation information corresponding to the control.

Referring to FIG. 4, the vehicle-mounted system displays a virtual interface that is the same as the interface of the portable terminal by receiving the interface image information sent by the portable terminal.

Specifically, the interface displayed by the portable terminal includes various interface elements presented to a user, which may employ a manner similar to screen copy and send a copied image of the screen of the portable terminal to the vehicle-mounted system, and make adaptive adjustments according to the screen of the vehicle-mounted system, such that the vehicle-mounted system displays the virtual interface that is the same as the interface of the portable terminal.

Specifically, the interface displayed by the portable terminal includes various controls for controlling the portable terminal, including various touch keys, such that the user may send operation instructions to the portable terminal by using the controls. In this way, events corresponding to the operation instructions are generated, and operation data corresponding to the operation instructions is generated.

Referring to Table 1, various controls on the interface of the portable terminal and operation instructions corresponding to the controls are exemplarily illustrated.

TABLE 1

| Control | Operation instruction |
|---|---|
| Camera | Take a photograph |
| Telephone | Make a call |
| . . . | . . . |
| Video APP | Play a video |

The vehicle-mounted system enables, according to the interface control information sent by the portable terminal, the virtual controls on the virtual interface to correspond to the controls on the interface of the portable terminal, to ensure that the various virtual controls on the virtual interface correspond to the operation instructions of the various controls on the interface of the portable terminal.

Referring to Table 2, virtual controls on the virtual interface of the vehicle-mounted system and operation instructions corresponding to various controls on the interface of the portable terminal are exemplarily illustrated.

TABLE 2

| Virtual control | Control | Operation instruction |
|---|---|---|
| Camera | Camera | Take a photograph |
| Telephone | Telephone | Make a call |
| . . . | . . . | . . . |
| Video APP | Video APP | Play a video |

Specifically, the vehicle-mounted system displays a virtual interface that is the same as that of the portable terminal, and receives input instructions via virtual controls on the virtual interface. By means of querying in Table 2, operation instructions corresponding to the input instructions of the virtual controls are acquired, and then the operation instructions are sent to the portable terminal. For example, the user may generate an operation instruction for making a call by touch a call key, and send the operation instruction for making a call to the portable terminal.

The portable terminal performs corresponding operations according to the operation instruction, generates corresponding operation data, and sends the generated operation data to the vehicle-mounted system. For example, the portable terminal makes a call according to the operation instruction for making a call, generates call data, and sends the call data to the vehicle-mounted system.

The vehicle-mounted system receives the operation data generated according to the operation instructions that is sent by the portable terminal, and outputs the operation data via a display and a player of the vehicle-mounted system.

The size of the display in the input/output module 13 of the vehicle-mounted system is greater than that of the portable terminal, and the player achieves a better play effect. Therefore, the operation data output by the vehicle-mounted system may achieve a better effect and user experience.

According to the present disclosure, resources are shared between the vehicle-mounted system and the portable terminal, the display and play effects of the portable terminal are improved, and the disclosure of the vehicle-mounted system is extended.

Another specific embodiment of the present disclosure provides an electronic device for use in vehicle-mounted display control, applied to a portable terminal, the portable terminal being connected to a vehicle-mounted system. Specifically, the vehicle-mounted system may be connected to the portable terminal via a local area network.

Referring to FIG. 6, the portable terminal may be generally a Pad, a smart phone or the like electronic device, and include in terms of hardware: a control chip 61, a memory 62, an input/output module 63, and hardware 64. The control chip 61 controls various functional modules, the memory 62 stores various disclosures and data, and the input/output module 63 is configured to implement input and output.

Referring to FIG. 9, the electronic device for use in vehicle-mounted display control includes:

an information sending module 91, configured to send displayed interface information to the vehicle-mounted system;

a data generating module 92, configured to receive an operation instruction sent by the vehicle-mounted system, and generate corresponding operation data according to the operation instruction; and

a data sending module 93, configured to send the operation data to the vehicle-mounted system, such that the vehicle-mounted system outputs the operation data.

The portable terminal sends the interface image information and the interface control information displayed thereon to the vehicle-mounted system, to ensure that the vehicle-mounted system is capable of displaying an interface that is the same as the portable terminal, and acquiring a control operation that is the same as the display interface of the portable terminal.

The portable terminal sends the displayed interface information to the vehicle-mounted system. Specifically, the interface information includes: interface image information and interface control information.

The interface image information includes at least one of: a display size, a color depth feature, a refresh rate and a resolution.

The interface image information includes at least one of: a display size, a color depth feature, a refresh rate and a resolution.

Specifically, the interface displayed by the portable terminal includes various interface elements presented to a user, which may employ a manner similar to screen copy and send a copied image of the screen of the portable terminal to the vehicle-mounted system, and make adaptive adjustments according to the screen of the vehicle-mounted system, such that the vehicle-mounted system displays the virtual interface that is the same as the interface of the portable terminal.

The interface displayed by the portable terminal includes various controls for controlling the portable terminal, including various touch keys, such that the user may send operation instructions to the portable terminal by using the controls. In this way, events corresponding to the operation instructions are generated, and operation data corresponding to the operation instructions is generated.

Referring to Table 1, various controls on the interface of the portable terminal and operation instructions corresponding to the controls are exemplarily illustrated.

TABLE 1

| Control | Operation instruction |
|---|---|
| Camera | Take a photograph |
| Telephone | Make a call |
| . . . | . . . |
| Video APP | Play a video |

Referring to FIG. 4, the vehicle-mounted system displays a virtual interface that is the same as the interface of the portable terminal by receiving the interface image information sent by the portable terminal.

The vehicle-mounted system enables, according to the interface control information sent by the portable terminal, the virtual controls on the virtual interface to correspond to the controls on the interface of the portable terminal, to ensure that the various virtual controls on the virtual interface correspond to the operation instructions of the various controls on the interface of the portable terminal.

Referring to Table 2, virtual controls on the virtual interface of the vehicle-mounted system and operation instructions corresponding to various controls on the interface of the portable terminal are exemplarily illustrated.

TABLE 2

| Virtual control | Control | Operation instruction |
|---|---|---|
| Camera | Camera | Take a photograph |
| Telephone | Telephone | Make a call |
| . . . | . . . | . . . |
| Video APP | Video APP | Play a video |

Specifically, the vehicle-mounted system displays a virtual interface that is the same as that of the portable terminal, and receives input instructions via virtual controls on the virtual interface. By means of querying in Table 2, operation instructions corresponding to the input instructions of the virtual controls are acquired, and then the operation instructions are sent to the portable terminal. For example, the user may generate an operation instruction for making a call by touch a call key, and send the operation instruction for making a call to the portable terminal.

The portable terminal receives operation instructions sent by the vehicle-mounted system, and generate corresponding operation data according to the operation instructions. For example, the portable terminal makes a call according to the operation instruction for making a call, and generates call data.

The portable terminal sends the operation data generated according to the operation instructions to the vehicle-mounted system, and outputs the operation data via a display and a player of the vehicle-mounted system.

The size of the display in the input/output module 13 of the vehicle-mounted system is greater than that of the portable terminal, and the player achieves a better play effect. Therefore, the operation data output by the vehicle-mounted system may achieve a better effect and user experience.

According to the present disclosure, resources are shared between the vehicle-mounted system and the portable terminal, the display and play effects of the portable terminal are improved, and the disclosure of the vehicle-mounted system is extended.

The following further describes an implementation of the present disclosure with reference to a specific disclosure scenario.

Referring to FIG. 10, a smart phone 101 is connected to a vehicle computer 102 via a local area network inside the vehicle, and instruction and data transmission is implemented therebetween via the local area network.

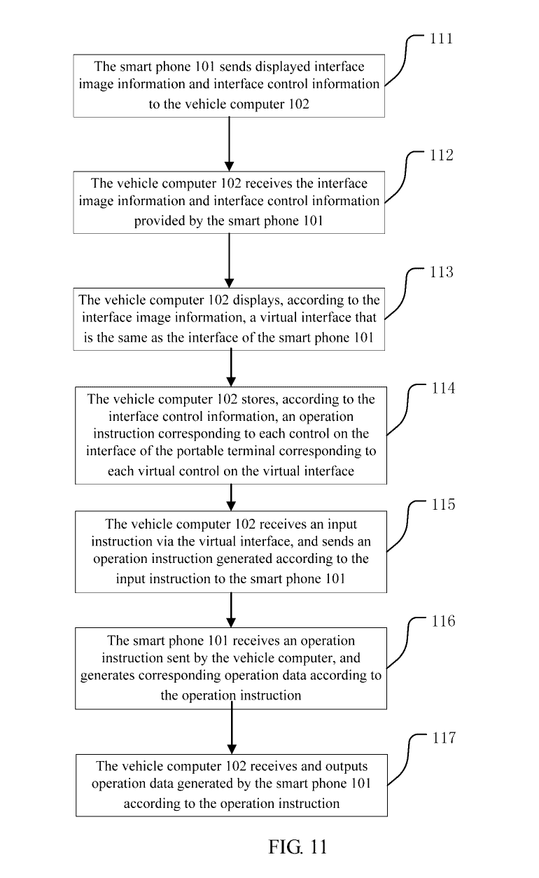

Referring to FIG. 11, the vehicle-mounted display control method applied to the smart phone 101 and the vehicle computer 102 includes the following steps:

111. The smart phone 101 sends displayed interface image information and interface control information to the vehicle computer 102.

112: The vehicle computer 102 receives the interface image information and interface control information provided by the smart phone 101.

Specifically, the interface image information includes at least one of: a display size, a color depth feature, a refresh rate and a resolution.

The interface control information includes operation information corresponding to the control.

113: The vehicle computer 102 displays, according to the interface image information, a virtual interface that is the same as the interface of the smart phone 101.

Referring to FIG. 4, the vehicle computer 102 displays a virtual interface that is the same as the interface of the portable terminal by receiving the interface image information sent by the smart phone 101.

Specifically, the interface displayed by the smart phone 101 includes various interface elements presented to a user, which may employ a manner similar to screen copy and send a copied image of the screen of the smart phone 101 to the vehicle computer 102, and make adaptive adjustments according to the screen of the vehicle computer 102, such that the vehicle computer 102 displays the virtual interface that is the same as the interface of the Smart phone.

114: The vehicle computer 102 stores, according to the interface control information, an operation instruction corresponding to each control on the interface of the portable terminal corresponding to each virtual control on the virtual interface.

Specifically, the interface displayed by the smart phone 101 includes various controls for controlling the smart phone 101, including various touch keys, such that the user may send operation instructions to the Smart phone by using the controls. In this way, events corresponding to the operation instructions are generated, and operation data corresponding to the operation instructions is generated.

Referring to Table 1, various controls on the interface of the smart phone 101 and operation instructions corresponding to the controls are exemplarily illustrated.

TABLE 1

| Control | Operation instruction |
|---|---|
| Camera | Take a photograph |
| Telephone | Make a call |
| . . . | . . . |
| Video APP | Play a video |

The vehicle computer 102 enables, according to the interface control information sent by the smart phone 101, the virtual controls on the virtual interface to correspond to the controls on the interface of the smart phone 101, to ensure that the various virtual controls on the virtual interface correspond to the operation instructions of the various controls on the interface of the smart phone 101.

Referring to Table 2, virtual controls on the virtual interface of the vehicle computer 102 and operation instructions corresponding to various controls on the interface of the smart phone 101 are exemplarily illustrated.

TABLE 2

| Virtual | | |
|---|---|---|
| control | Control | Operation instruction |
| Camera | Camera | Take a photograph |
| Telephone | Telephone | Make a call |
| . . . | . . . | . . . |
| Video APP | Video APP | Play a video |

115: The vehicle computer 102 receives an input instruction via the virtual interface, and sends an operation instruction generated according to the input instruction to the smart phone 101.

Specifically, the vehicle computer 102 displays a virtual interface that is the same as that of the smart phone 101, and receives input instructions via virtual controls on the virtual interface. By means of querying in Table 2, operation instructions corresponding to the input instructions of the virtual controls are acquired, and then the operation instructions are sent to the smart phone 101. For example, the user may generate an operation instruction for making a call by touch a call key, and send the operation instruction for making a call to the smart phone 101.

The smart phone 101 performs corresponding operations according to the operation instruction, generates corresponding operation data, and sends the generated operation data to the vehicle computer 102. For example, the smart phone 101 makes a call according to the operation instruction for making a call, generates call data, and sends the call data to the vehicle computer 102.

116: The smart phone 101 receives an operation instruction sent by the vehicle computer, and generates corresponding operation data according to the operation instruction.

The portable terminal receives operation instructions sent by the vehicle-mounted system, and generate corresponding operation data according to the operation instructions. For example, the portable terminal makes a call according to the operation instruction for making a call, and generates call data.

117. The vehicle computer 102 receives and outputs operation data generated by the smart phone 101 according to the operation instruction.

The vehicle computer 102 receives the operation data generated according to the operation instructions that is sent by the smart phone 101, and outputs the operation data via a display and a player of the vehicle computer 102.

According to the present disclosure, videos stored locally or downloaded may be played by using the vehicle computer 102, photographs (for example, photographs taken by the passengers by stretching their mobile phones outside the windows) taken by the may be displayed, and calls may be made by using the vehicle computer 102. The sire of the display of the vehicle computer 102 is greater than that of the smart phone 101, and thus the player has a better play effect. Therefore, the operation data output by the vehicle computer 102 may achieve a better effect and user experience.

According to the present disclosure, resources are shared between the vehicle computer 102 and the smart phone 101, the display and play effects of the smart phone 101 are improved, and the disclosure of the vehicle computer 102 is extended.

An embodiment of the present disclosure provides a non-volatile computer storage medium, wherein the computer storage medium stores computer executable instructions, which may be executed to perform the display control method in any of the above method embodiments.

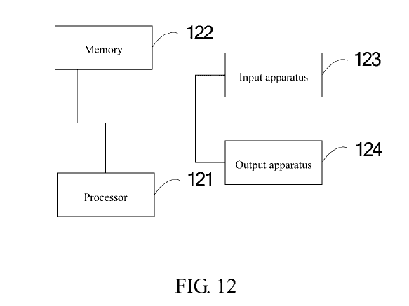

FIG. 12 is a schematic structural diagram illustrating hardware of an electronic device for performing the display control method according to an embodiment of the present disclosure.

As illustrated in FIG. 12, the electronic device includes at least one processor 121 and a memory 122, and FIG. 12 uses one processor 121 as an example.

The electronic device for performing the display control method may further include: an input apparatus 123 and an output apparatus 124.

The processor 121, the memory 122, the input apparatus 123 and the output apparatus 124 may be connected to each other via a bus or in another manner. FIG. 6 uses connection via a bus as an example for description.

The memory 122, as a non-volatile computer readable storage medium, may be configured to store non-volatile software programs, non-volatile computer executable programs and modules, for example, the program instructions/modules corresponding to the display control method in the embodiments of the present disclosure. The non-volatile software programs, instructions and modules stored in the memory 122, when being executed, cause the processor 121 to perform various function disclosures and data processing of a server, that is, performing the display control method in the above method embodiments.

The memory 122 may also include a program storage area and a data storage area. The program storage area may store an operating system and an disclosure implementing at least one function. The data storage area may data created according to use of the vehicle-mounted display control apparatus. In addition, the memory 122 may include a high speed random access memory, or include a non-volatile memory, for example, at least one disk storage device, a flash memory device, or another non-volatile solid storage device. In some embodiments, the memory 122 optionally includes memories remotely configured relative to the processor 121. These remote memories may be connected to the vehicle-mounted display control apparatus over a network. The above examples include, but not limited to, the Internet, Intranet, local area network, mobile communication network and a combination thereof.

The input apparatus 123 may receive input digital or character information, and generate signal input related to user settings and function control of the vehicle-mounted display control apparatus. The output apparatus 124 may include a display screen or the like display device.

The one or more modules are stored in the memory 122, and when being executed by the at least one processor 121, perform the display control method in any of the above method embodiments.

The product may perform the method according to the embodiments of the present disclosure, has corresponding function modules for performing the method, and achieves the corresponding beneficial effects. For technical details that are not illustrated in detail in this embodiment, reference may be made to the description of the methods according to the embodiments of the present disclosure.

The electronic device in the embodiments of the present disclosure is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, an MID, an UMPC device and the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device; and

(5) another electronic device having the data interaction function.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part or all of the modules may be selected according to the actual needs to achieve the objectives of the technical solutions of the embodiments.

According to the above embodiments of the present disclosure, a person skilled in the art may clearly understand that the embodiments of the present disclosure may be implemented by means of hardware or by means of software plus a necessary general hardware platform. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A vehicle-mounted display control method, applied to a vehicle-mounted system, the vehicle-mounted system being connected to a portable terminal, the method comprising:
receiving interface information sent by the portable terminal, and displaying a virtual interface according to the interface information;
receiving an input instruction via the virtual interface, and sending an operation instruction generated according to the input instruction to the portable terminal; and
receiving and outputting operation data generated by the portable terminal according to the operation instruction.

2. The method according to claim 1, wherein the receiving interface information sent by the portable terminal, and displaying a virtual interface according to the interface information comprises:
receiving interface image information and interface control information provided by the portable terminal;
displaying, according to the interface image information, a virtual interface that is the same as the interface of the portable terminal; and
storing, according to the interface control information, an operation instruction corresponding to each control on the interface of the portable terminal corresponding to each virtual control on the virtual interface.

3. The method according to claim 2, wherein the interface image information comprises at least one of: a display size, a color depth feature, a refresh rate and a resolution.

4. The method according to claim 2, wherein the interface control information comprises operation information corresponding to the control.

5. A non-transitory computer-readable storage medium storing computer executable instructions, wherein the computer instructions are executed to:
receive interface information sent by the portable terminal, and display a virtual interface according to the interface information;
receive an input instruction via the virtual interface, and send an operation instruction generated according to the input instruction to the portable terminal; and
receive and output operation data generated by the portable terminal according to the operation instruction.

6. The non-transitory computer-readable storage medium according to claim 5, wherein the receiving interface information sent by the portable terminal, and displaying a virtual interface according to the interface information comprises:
receiving interface image information and interface control information provided by the portable terminal;
displaying, according to the interface image information, a virtual interface that is the same as the interface of the portable terminal; and
storing, according to the interface control information, an operation instruction corresponding to each control on the interface of the portable terminal corresponding to each virtual control on the virtual interface.

7. The non-transitory computer-readable storage medium according to claim 6, wherein the interface image information comprises at least one of: a display size, a color depth feature, a refresh rate and a resolution.

8. The non-transitory computer-readable storage medium according to claim 6, wherein the interface control information comprises operation information corresponding to the control.

9. An electronic device, comprising:
at least one processor; and
a memory communicably connected to the at least one processor; wherein
the memory stores instructions executable by the at least one processor, wherein, the instructions, when being executed by the at least one processor, cause the at least one processor to:
receive interface information sent by the portable terminal, and display a virtual interface according to the interface information;
receive an input instruction via the virtual interface, and send an operation instruction generated according to the input instruction to the portable terminal; and
receive and output operation data generated by the portable terminal according to the operation instruction.

10. The electronic device according to claim 9, wherein the receiving interface image information and interface control information provided by the portable terminal comprises:
receiving interface image information and interface control information provided by the portable terminal;
displaying, according to the interface image information, a virtual interface that is the same as the interface of the portable terminal; and
storing, according to the interface control information, an operation instruction corresponding to each control on the interface of the portable terminal corresponding to each virtual control on the virtual interface.

11. The electronic device according to claim 10, wherein the displaying, according to the interface image information, a virtual interface that is the same as the interface of the portable terminal comprises at least one of: a display size, a color depth feature, a refresh rate and a resolution.

12. The electronic device according to claim 10, wherein the interface control information comprises operation information corresponding to the control.
